(19) United States
(12) Patent Application Publication
(10) Pub. No.: US 2005/0079908 A1
(43) Pub. Date: Apr. 14, 2005

(54) Gaming machine having an award-trading scheme

(76) Inventor: Larry J. Pacey, Northbrook, IL (US)

Correspondence Address: JENKENS & GILCHRIST, P.C., 225 WEST WASHINGTON, SUITE 2600, CHICAGO, IL, 60606, US

(21) Appl. No.: 10/684,353

(22) Filed: Oct. 10, 2003

(51) Int. Cl. A63F 13/00

(52) U.S. Cl. 463/20

(57) ABSTRACT

The present invention is a gaming machine having an award-trading scheme and a method for conducting the award-trading scheme. The method includes receiving a wager to play the wagering base game and detecting a winning outcome to the wagering base game, and providing a first award option to a player of the wagering base game, where the first award option is displayed on a video display of the gaming machine. The method also includes precluding the player from receiving the winning credits and awarding the first award option to the player in response to the first award option being exercised by the player. The method further includes providing a second award option in response to the first award option not being exercised by the player. The first and second award options can include credits and free game play, to name a few.

### FIELD OF THE DISCLOSURE

This invention is directed to gaming machines, and more particularly, to a gaming machine having an award-trading scheme.

### BACKGROUND

Gaming machines providing base games such as electronically driven video slots, video poker, video blackjack, video keno, video bingo, video pachinko, video lottery, and mechanically driven reel slots, etc., are well known in the gaming industry. Generally gaming machines are configured to operate as “stand-alone” units (that may or may not be coupled to a backroom computer) where the outcome of game play is “locally determined”, or as part of a server-based gaming network where the outcome of game play may be either locally determined or “centrally determined”.

Typically, video gaming machines are configured with a main video display for displaying video game images including video images representing game play outcome (e.g., simulated reel symbols in the case of a slot game, simulated cards, simulated numbers, etc.). In addition to displaying game play information (e.g., game outcome, status of game play including credits, lines bets, etc.), the main video display may be configured with a touch screen to allow player interaction. The player can make a number of game play selections by touching “virtual” buttons or particular touch-sensitive areas provided on the main video display. Alternatively, the player can make game play selections by depressing various electromechanical buttons provided on a player control panel.

Mechanical spinning reel slot machines, on the other hand, generally include a main reel display area configured to allow a player to view a reel symbol array provided by the stopped mechanical spinning reels. The player can make game play selections by depressing various electromechanical buttons provided on a player control panel.

Typical base game play follows a somewhat predicable cycle. That is, the player makes wagering game selections, initiates game play, is provided a “random” game outcome and either wins or loses. Recently, secondary or bonus games have been used in conjunction with base games to enhance overall game play. Bonus game play is exciting to the player because the player is generally required to perform “bonus activities” or new tasks that are not necessarily required for base game play. In addition, bonus game play generally results in a win for the player.

Typically, bonus game play is triggered by an “event” during base game play. The event may be the occurrence of a symbol or symbols. The event may also be randomly generated or may be triggered by the number of credits spent, time of day, etc. Once triggered, bonus game play may require the player to perform one of any number of fun bonus activities such as choosing between a guaranteed number of credits and game play that may or may not result in additional credits, spinning a wheel to win additional credits, and so on. Thus, a triggering event must occur during base game play before the player is permitted to play the bonus game and enjoy the benefits associated with bonus game play.

### SUMMARY OF THE INVENTION

In general, the present invention provides a gaming machine having an award-trading scheme whereby, for randomly selected winning outcomes during base game play, a player is provided with an award option. When the award option is selected by the player, the player is precluded from accepting the credits resulting from the winning outcome and instead receives the award associated with the option. In other words, the player trades the credits associated with the winning outcome for the award associated with the award option. Thus, the award option is provided to the player during base game play and therefore the player is permitted to enjoy the benefits typically associated with bonus game play without waiting for an occurrence of a bonus triggering event.

Stated more specifically, an embodiment of the award-trading scheme includes receiving a wager to play the wagering base game and detecting a winning outcome to the wagering base game, and providing a first award option to a player of the wagering base game, where the first award option is displayed on a video display of the gaming machine. The award-trading scheme also includes precluding the player from receiving the winning credits and awarding the first award option to the player in response to the first award option being exercised by the player. In addition, the award-trading scheme may include providing a second award option in response to the first award option not being exercised by the player where the second award option is more valuable to the player than the first award option.

In addition to detecting a winning outcome, the first award option may be provided to the player in response to an occurrence of a pre-selected symbol or a symbol combination occurring during base game play. The first and second award options may also be provided to the player as a result of operation of a random output generator device (e.g., a random number generator (RNG), pooled tickets, etc.), or may be provided based on predetermined criterion such as player identity, promotional events, the number of base games played, a dollar amount or credit amount played or won by the player, player tracking data, the time of day, day of week, etc.

For slot game play, the award options preferably comprises at least one “free” spin that may include (1) a multiplied winning outcome resulting from a double, triple, etc., winning symbol array payout, or a double, triple, etc. individual symbol value, and/or (2) an enhanced symbol array due to additional wild symbols, right to left pays, making symbols pay as scatters, etc., (3) additional credits and/or (4) a chance for bonus game play. For non-slot game play, each of the award options preferably includes (1) base game play not requiring a wager (2) additional credits and/or (3) a chance for bonus game play. In the case of either slot or non-slot game play the bonus game play may include a bonus award-trading scheme.

A further embodiment of the award-trading scheme includes receiving a wager to play the wagering base game, concealing from the player an outcome to the wagering base game, and providing a first award option to a player of the wagering base game. The award-trading scheme also includes precluding the player from receiving winning credits associated with the outcome and awarding the first award option to the player in response to the first award option being exercised by the player.

An embodiment of a bonus award-trading scheme includes providing a plurality of pick tiles on the video display where each of the plurality of pick tiles is associated with a hidden credit award, and detecting player selection of a first pick tile from the plurality of pick tiles where the player selection of the first pick tile reveals a first credit award to the player. The bonus award-trading scheme also includes providing a first bonus award option to the player and, in response to the first bonus award option being exercised by the player, (1) precluding the player from receiving the first credit award, (2) precluding the player from selecting additional pick tiles from the plurality of pick tiles and (3) awarding the first bonus award option to the player. In addition, in response to the first bonus award option not being exercised by the player, the bonus award-trading scheme includes enabling player selection of a second pick tile associated with a second credit award, detecting player selection of the second pick tile, displaying a sum of the first credit award and the second credit award on the video display, providing a second bonus award option to the player. Further, in response to the second bonus award option being exercised by the player, the bonus award-trading scheme includes precluding the player from receiving the sum, awarding the second bonus award option to the player and precluding the player from selecting a third pick tile from the plurality of pick tiles.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of an embodiment of a gaming machine offering an award-trading scheme in accordance the invention.

FIG. 2 is a block diagram of the electronic components of the gaming machine of FIG. 1.

FIG. 3 is a flowchart of an embodiment of an award-trading scheme routine that may be performed during wagering base game play of the gaming machine of FIG. 1.

FIG. 4 is a flowchart of another embodiment of an award-trading scheme routine that may be performed during wagering base game play of the gaming machine of FIG. 1.

FIG. 5 is a flowchart of an embodiment of a bonus award-trading scheme routine that may be performed during bonus game play of the gaming machine of FIG. 1.

FIGS. 6-10 are a series of exemplary display screens that may be displayed during performance of the award-trading scheme routine of FIG. 3.

FIG. 11 is an exemplary display screen that may be displayed during performance of the award-trading scheme routine of FIG. 4.

FIG. 12 is an exemplary display screen that may be displayed prior to the bonus award-trading scheme routine of FIG. 5.

FIGS. 13-16 are a series of exemplary display screens that may be displayed during performance of the bonus award-trading scheme routine of FIG. 5.

### DESCRIPTION OF THE PREFERRED EXAMPLES

The description of the preferred examples is to be construed as exemplary only and does not describe every possible embodiment of the invention. Numerous alternative embodiments could be implemented, using either current technology or technology developed after the filing date of this patent, which would still fall within the scope of the claims defining the invention.

In general, the present invention provides a gaming machine having an award-trading scheme whereby, for randomly selected winning outcomes during base game play, a player is provided with an award option. When the award option is selected by the player, the player is precluded from accepting the credits resulting from the winning outcome and instead receives the award associated with the award option. In other words, the player trades the credits associated with the winning outcome for the award associated with the award option. Thus, the award option is provided to the player during base game play and therefore the player is permitted to enjoy the benefits typically associated with bonus game play without waiting for an occurrence of a bonus triggering event.

As described below, the present invention is preferably implemented using a video gaming machine. It is contemplated that the present invention may also be implemented using a mechanical spinning reel gaming machine having a secondary video display with a touch screen.

An advantageous feature of the gaming machine having an award-trading scheme during base game play is that the player does not have to wait for an occurrence of a bonus triggering event and bonus game play in order to the enjoy the benefits associated with bonus game play. Instead, the player is presented with award options during base game play which, depending on the award option selected, provide unpredictable and fun game play variations during the base game.

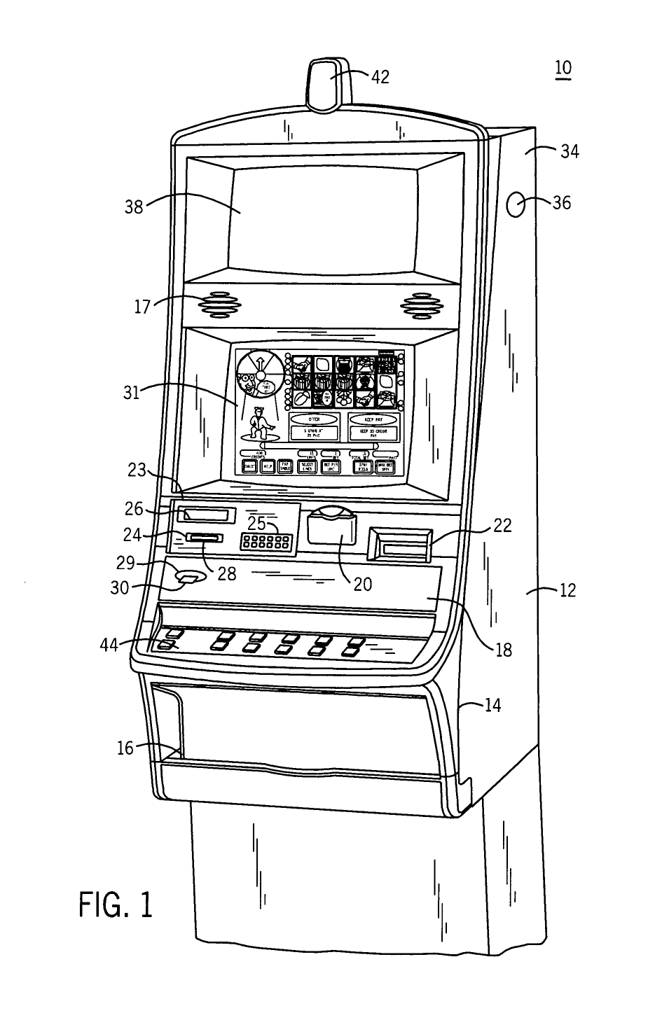

FIG. 1 is a perspective view of one possible embodiment of a gaming machine 10 offering an award-trading scheme during base game play. The gaming machine 10 may be any type of wagering gaming machine offering a player time-selectable bonus award and may therefore have varying structures and methods of operation. For example, the gaming machine 10 may be a video gaming machine configured to play a video wagering game, or it may be a mechanical spinning reel slot machine (with or without and arm mechanism) having a touch screen. For exemplary purposes, various elements of the gaming machine 10 are described below, but it should be understood that numerous other elements may exist and may be utilized in any number of combinations to create a variety of gaming machine types.

Referring to FIG. 1, the gaming machine 10 includes a cabinet 12 having a door 14 to provide access to the interior of the gaming machine 10. Attached to the door 14 are audio speaker(s) 17 and a belly glass area 18 that typically displays game theme artwork. The audio speaker(s) 17 may be used to generate a variety of sounds such as the sound of spinning slot machine reels, a dealer's voice, music, announcements or any other audio related to the wagering game.

Also attached to the door 14 are a number of value input devices that allow a player to insert value for game play. The value input devices may include a coin slot acceptor 20 or a note acceptor 22 to input value to the gaming machine 10. The note acceptor 22 may accept value in any number of forms, including currency or a currency-sized paper ticket voucher inscribed with information such as a bar code representing value, the name of the casino, the date, etc. As used herein, the term “value” may encompass gaming tokens, coins, paper currency, ticket vouchers, credit or debit cards, smart cards, and any other object representative of value.

The gaming machine 10 may also include a player tracking area 23 having a card reader 24, a keypad 25 and a small display 26. As will be appreciated by those of ordinary skill in the art, the player tracking area 23 may be located in any number of areas of the gaming machine 10. The small display 26 may be implemented using a vacuum fluorescent display (VFD), a liquid crystal display (LCD), an LED display, and/or a touch screen to display information to a game player or casino employee. The card reader 24 may include any type of card reading device, such as a magnetic card reader, memory card reader, an optical card reader, etc. The card reader 24 may be used to read data from a card (e.g., a credit card, a player tracking card, a smart card, etc.) offered by a player. If provided for player tracking purposes, the card reader 24 may be used to read data from, and/or write data to, cards capable of storing data. Such data may include the identity of a player, the identity of a casino, the player's gaming habits, etc. Once gathered, the data can be “mined” (i.e., the data is sorted to identify patterns and establish relationships) for any number of purposes including administering player awards, distinguishing player preferences and habits, accounting, etc.

The gaming machine 10 also includes a main display device 31 for displaying video game images (e.g., simulated reel symbols, simulated cards, simulated numbers, etc.), or in the case of a mechanical spinning reel slot machine, for displaying a symbol array of artwork and blank symbols affixed to mechanical spinning reels viewable to the player. The symbol array may include occurrences of non-winning symbol combinations where no value payout is awarded to the player, or occurrences of winning symbol combinations (reflected in a pay table) where value payouts are awarded to the player. In addition, the main display device 31 may display animation, 2-D or 3-D images and digital video playback.

For video gaming machines, the main display device 31 may be implemented as a CRT, an LCD, a plasma display, an organic liquid crystal display or other type of video display suitable for use in a gaming machine, and includes a touch screen. For example, in a video gaming machine offering a slot game, the main display device 31 may include an LCD-TFT display displaying video reel artwork symbols and blank symbols.

For mechanical spinning reel slot machines, the main display device 31 includes a reel display area and may additionally include a touch screen. Alternatively, the touch screen may be provided at a location disposed part from the main display device 31. The reel display area is adapted to display game information to a player while, at the same time, allowing the player to view the reel symbol array provided by the stopped mechanical spinning reels. The game information displayed to the player may include game denominations, available credits, pay lines, wagering information, and other suitable game information. When the mechanical spinning reels are rotated and stopped, the resulting symbol array in conjunction with game information displayed in the reel display area provide a game outcome and game status to the player.

Referring again to FIG. 1, the gaming machine 10 may also include a box top 34 having additional speaker(s) 36 and a top box display device 38. Although not separately illustrated, the top box display device 38 may include a camera and/or a microphone, and/or physical objects such as mechanical reels, wheels, or dice. The top box display device 38, if configured as a dynamic display (e.g., a flat panel video display), may enable a number of game enhancements such as bonus games, interactive tournament games, progressive jackpot games, etc. Alternatively, the top box display device 38, if configured as a static display, may display award information such as pay tables for base or bonus games via glass art.

The gaming machine 10 may also include a player control panel 44. The player control panel 44 may be provided with a number of pushbuttons or touch-sensitive areas (i.e., touch screen) that may be pressed by a player to select games, make wagers, make gaming decisions, etc. As used herein, the term “button” is intended to encompass any device that allows a player to make an input, such as a mechanical input device that must be depressed to make an input selection or a display area that a player may simply touch. The number of pushbuttons may include one or more “Bet” buttons for wagering, a “Max Bet” button for making the maximum wager allowable for the game, a “Play” button for beginning pay, a “Repeat” button for repeating the previous wagering selection, a “Collect” button for terminating play and cashing out of the game, a “Help” button for viewing a help screen, a “See Pays” button for causing the main display device 31 to generate one or more display screens showing the odds or payout information for the game or games provided by the gaming machine 10, and a “Call Attendant” button for calling an attendant. Further, although the player control panel 44 is shown to be separate from the main display device 31, it should be understood that the control panel 44 could be generated as a touch-sensitive screen by the main display device 31.

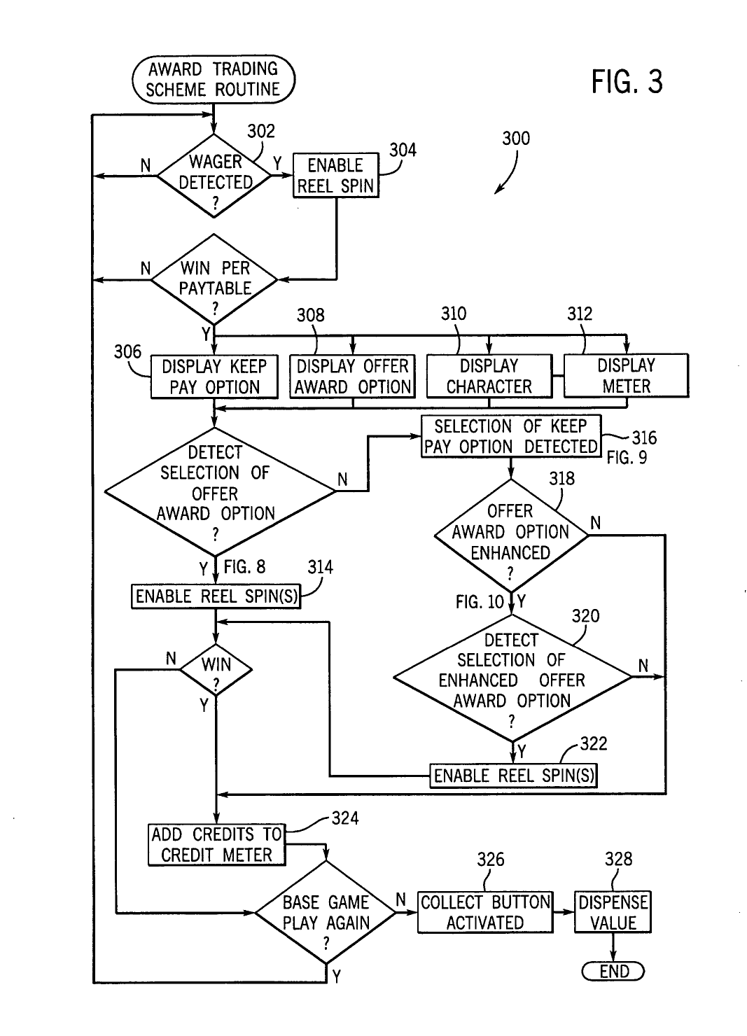

Referring again to FIG. 1, when a player inserts value in the gaming machine 10, credits corresponding to the amount deposited are displayed on a credit meter of the gaming machine 10. After depositing the appropriate amount of value and making appropriate selections, the player begins game play by pulling a mechanical arm or by pushing an appropriate button such as a Bet button, a Max Bet button, or a Play button on the player control panel 44. Subsequent game play outcome displayed via the main display device 31 may be determined either centrally or locally (1) using a random number generator (RNG) resulting in a pseudo random set of outcomes, or (2) by selecting a game outcome from a fixed set of outcomes (pooled), or (3) other suitable technique. Additional details describing game play on the gaming machine 10 having an award-trading scheme are included below as described in FIG. 3.

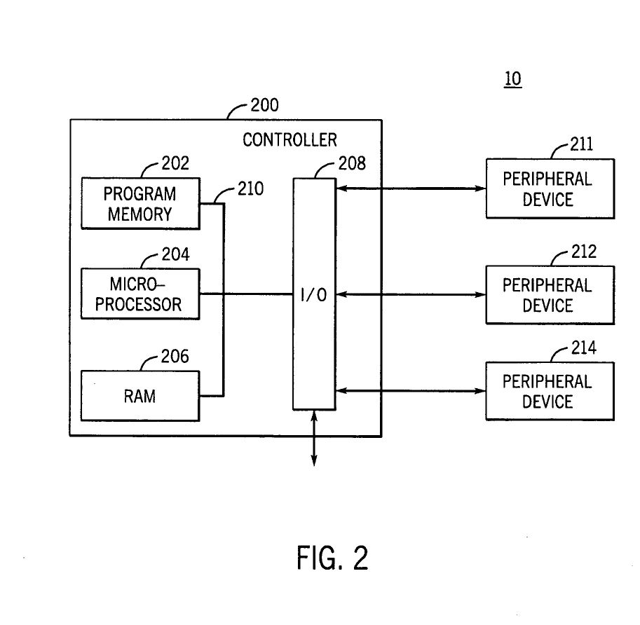

FIG. 2 is a block diagram of a number of components that may be incorporated in the gaming machine 10 of FIG. 1. Referring to FIG. 2, the gaming machine 10, includes a controller 200 that may comprise a program memory 202 (including a read only memory (ROM)), a microcontroller-based platform or microprocessor (MP) 204, a random-access memory (RAM) 206 and an input/output (I/O) circuit 208, all of which may be interconnected via a communications link, or an address/data bus 210. The microprocessor 204 is capable of displaying images, symbols and other indicia such as characters, people, places, things, and faces of cards. The RAM 206 is capable of storing event data or other data used or generated during a particular game. The program memory 202 is capable of storing program code that controls the gaming machine 10 so that it plays a particular game in accordance with applicable math models, game rules, and pay tables. For example, when an award option is offered to a player of a slot game, the microprocessor 204, executing code in the program memory 202, causes an “Offer award option” and a “Keep Pay option” prompt to be displayed and then enables game subsequent game play based on the option selected by the player.

It should be appreciated that although only one microprocessor 204 is shown, the controller 200 may include multiple microprocessors 204. For example, the controller 200 may include one microprocessor for executing low level gaming functions and another processor for executing higher-level game functions such as some communications, security, maintenance, etc. Similarly, the memory of the controller 200 may include multiple RAMs 206 and multiple program memories 202, depending on the requirements of the gaming machine 10. Although the I/O circuit 208 is shown as a single block, it should be appreciated that the I/O circuit 208 may include a number of different types of I/O circuits. The RAM(s) 206 and program memory(s) 202 may be implemented as semiconductor memories, magnetically readable memories, and/or optically readable memories, etc. Further, the term “controller” is used herein to refer collectively to the program memory 202, the microprocessor 204, the RAM 206 and the I/O circuit 208.

FIG. 2 illustrates that multiple peripheral devices, depicted as peripheral devices 211, 212, and 214, may be operatively coupled to the I/O circuit 208. The peripheral devices may include a control panel with buttons, a coin slot acceptor, a note acceptor, a bill validator, a card reader, a keypad, a sound circuit driving speakers, a card reader display, a video display, a touch screen, etc. In the case of a spinning reel slot machine, the peripheral devices may include a number of electro-mechanical spinning reels and a mechanical arm similarly coupled to the I/O circuit 208. Although three peripheral devices are depicted, more or less peripheral devices may be included.

It should be appreciated that although the controller 200 is a preferable implementation of the present invention, the present invention also includes implementation via one or more application specific integrated circuits (ASICs), field programmable gate arrays (FPGA), adaptable computing integrated circuits, one or more hardwired devices, or one or more mechanical devices.

One manner in which the gaming machine 10 may operate is described below in connection with one or more flowchart(s) that represents a number of portions or routines of one or more computer programs, which may be stored in one or more of the memories of the controller 200. The computer program(s) or portions thereof may also be stored remotely, outside of the gaming machine 10 and may therefore control the operation from a remote location.

As previously mentioned, typically a bonus triggering event must occur during base game play before the player is permitted to participate in bonus game play. The gaming machine 10 having an award-trading scheme however, is configured so that the player does not have to wait for an occurrence of a bonus triggering event in order to the enjoy the benefits associated with bonus game play. Instead, the player is presented with award options during base game play which, depending on the award option selected, provide the “feel” of bonus game play during the base game.

FIG. 3 is a flowchart of an award-trading scheme routine 300 that may be performed by the controller 200 of the gaming machine 10 during base game play. Alternatively, the award-trading scheme routine 300 may be performed by another controller coupled to the gaming machine 10. The award-trading scheme routine 300 provides but one example of a player selecting from among award options during base game play on the gaming machine 10. Although discussed below in the context of a slot game for illustrative purposes, it is contemplated the award-trading scheme routine 300 may be executed in conjunction with any number of other wagering base or bonus games provided by gaming machines.

Referring to FIG. 3, the award-trading scheme routine 300 begins operation when the controller 200 detects a wager for base game play (step 302). Detection of a wager includes detecting a value input and detecting a bet. The controller 200 detects the value input when a player deposits one or more of coins, paper currency, a card, or a voucher into a value input device of the gaming machine 10. When the controller 200 detects the value input, a number of credits corresponding to the amount deposited are displayed on a credit meter of the main display device 31. After value input detection, the controller 200 enables a pay line selection. If there is only one pay line, the controller 200 enables initiation of base game play. If there is more than one pay line, the controller 200 also enables a bet-per-pay line selection. The bet-per-pay line selection causes an amount per pay line to be bet or wagered with the total wager divided equally between each selected pay line if multiple pay lines are selected. The bet-per-pay line is also displayed to the player via the bet meter. In addition, the controller 200 enables the player to select a maximum bet (via a “Max Bet Spin” button). Thus, the player may choose the maximum bet option causing maximum pay line selection and maximum credits rather than the pay line selection and the bet per pay line selection.

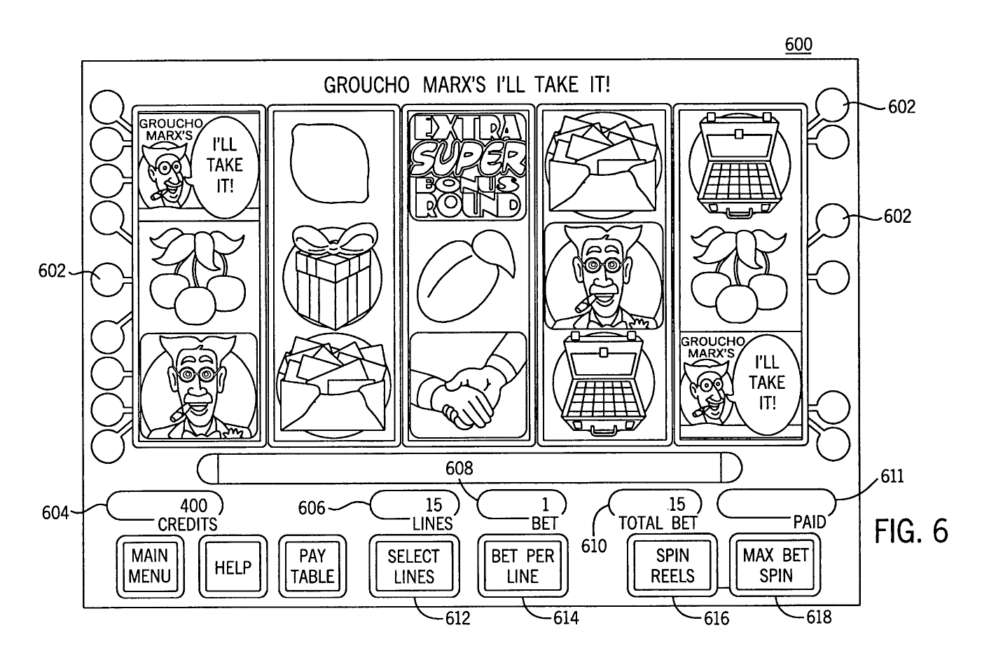

For example, FIG. 6 is an exemplary display screen 600 that may be initially displayed on the main display device 31 during performance of the award-trading scheme routine 300. In the illustrated example, the exemplary display screen 600 includes multiple pay lines 602, a credit meter 604 for displaying a number of credits available for base game play (e.g., 400 credits), a pay line indicator 606 for displaying the number of pay lines selected (e.g., 15 pay lines), a bet indicator 608 for displaying the number of credits wagered per pay line for a current game (e.g., 1 credit), a total bet indicator 610 for displaying the total credits wagered (e.g., 15 credits), and a paid indicator 611 for displaying credits won, if applicable, for the wager. Also included are a number of player selectable buttons such as a select lines button 612, a bet per line button 614, a spin reels button, 616, a max bet spin button 618, etc. Although illustrated as virtual touch screen buttons, the player selectable buttons may also be configured as mechanical buttons.

Referring again to FIG. 3, upon detecting the pay line(s) and bet-per-pay line selections (if applicable) and verifying the value input, the controller 200 enables play of the base game; in the illustrated example, enables video reel spin (step 304). The player may spin the reels of a slot game selecting the spin reels button 616 or by depressing a button such as a “Spin Reels” pushbutton provided on the player control panel 44 of the gaming machine 10. Alternatively, if the slot game is a mechanical spinning reel slot game utilizing a number of mechanical spinning reels, the player may pull a handle provided on the gaming machine 10 to initiate the reel spin. In either case, the controller 200, having determined a game outcome based on operation of a random generator device, stops the reels such that they display a symbol array representing the game outcome.

I. Award-Trading Scheme Where Value Payout is Displayed

If reel symbols on the stopped reels match one of the winning symbol combinations displayed on a pay table, the controller 200 displays a value payout associated with the winning symbol combination. The value payout may simply be displayed as credits displayed on the paid indicator 611 and therefore indicate that the player will not have further base game play unless another wager is detected. Alternatively, the controller 200 may cause the value payout to be included as part of an award-trading scheme and therefore be displayed as a player selectable touch screen image (step 306). One or more additional player selectable touch screen images representing various award options may also be displayed (step 308). In addition, the controller 200 causes an animated character (step 310) and an award option meter (step 312) to be displayed on the exemplary display screen 600. The animated character directs the player to select from among the award options while the award option meter provides a visual indication of the value of one of the displayed award option(s) to the player.

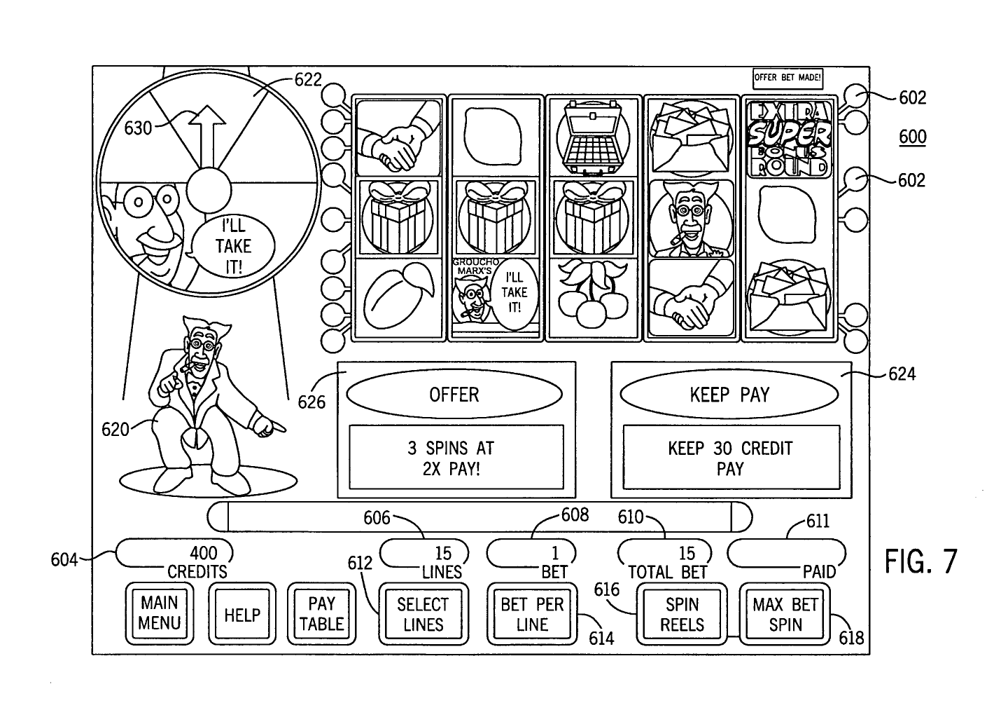

For example, FIG. 7 shows an embodiment of the exemplary display screen 600 that may be displayed upon completion of a winning reel spin during the award-trading scheme routine 300 when the value pay out is displayed. In the illustrated example, the controller 200 causes an animated character 620 (e.g., Grouch Marx) and an award option meter 622 to be displayed on the exemplary display screen 600. Preferably, the animated character 620 is position along side of the stopped video reels and appears to “talk” to the player. In addition, the controller 200 causes player selectable options to be displayed. The options are preferably displayed as player selectable touch screen images overlaid on a portion of the reel display area.

In the illustrated example, the award options include two player selectable options: (1) a “keep pay” option 624 (the keep pay option), which if selected, allows the player to keep the credits resulting from the winning symbol combination, and (2) an “offer award” option 626 (the offer award option) which if selected, allows the player to trade credits resulting from the winning symbol combination for the offer award option 626. Although only two player selectable options are displayed to the player, it is contemplated that any number of award options may be displayed, depending on the preferred design of the award-trading scheme.

The offer award option 626 may reflect one of any number of award options including, but not limited to, additional base game play with or without multiplied pay values (e.g., doubling, tripling, etc. the value of selected symbols or the value payout), additional base game play where symbols or other indicia are assigned a “wild” status (e.g., a plum symbol is a wild symbol), additional base game play enhanced with right to left pays, enabling value payouts based on a scattered winning symbol array rather than a pay line winning symbol array, a chance to play a bonus award-trading game, and so on.

The award option meter 622 provides a visual indication of the value of the offer award option. That is, the award option meter 622 imparts a clue to the player as to whether the offer award option 626 is a superior choice when compared to the credits resulting from the winning symbol combination (“the winning credits”). In the illustrated example, the award option meter 622 is configured as a disc having colored wedges. A needle 630, rotatable about a center axis of the disc, points to one of the colored wedges to indicate the value of the offer award option. For example, if the needle 630 points to a first colored wedge indicating a very good offer award option (e.g., a red colored wedge), the player may be more likely to select the offer award option rather than keep his/her winning credits. On the other hand, if the needle 630 points to a second colored wedge indicating an average offer award option (e.g., a green colored wedge), the player may be less likely to select the offer award option and instead select to keep his/her winning credits. As will be appreciated by those of ordinary skill in the art, the award option meter 622 may be configured in one of any number of ways to impart the clue to the player as to whether the offer award option is the superior choice.

a. The Player Selects the Offer Award Option

Referring again to FIG. 3, after an introductory comment by the animated character 620, the player is directed to select one of the award options; either the keep pay option 624 or the offer award option 626 in view of the award option meter 622. If the player selects the offer award option 626, the player trades the winning credits for the offer award option 626. If additional base game play is included in the offer award option 626, the controller 200 enables the additional base game play reflected in the offer award option 626 (step 314).

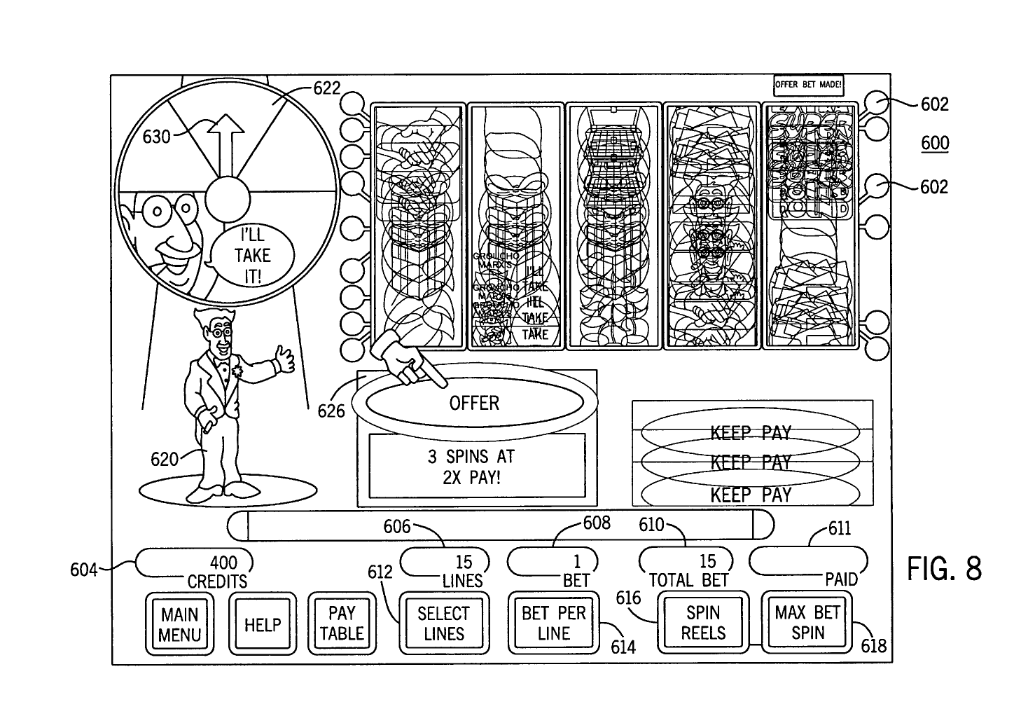

For example, in FIG. 8 the player selects the offer award option 626 by touching the offer award option 626. In the illustrated example, the offer award option 626 allows the player three reel spins where winning symbol combinations pays two times the amount shown on the pay table. The three reel spins, however, may or may not result in a winning symbol combination. Therefore, if one or more of the three reel spins does not yield a winning symbol combination, the player effectively “looses” the 30 credits he/she previously won. If, however, one or more of the three reel spins does yield a winning symbol combination, the player is rewarded accordingly.

b. The Player Does Not Select the Offer Award Option

Referring again to FIG. 3, if the player selects the keep pay option 624 (step 316) and therefore does not select the offer award option 626, the player may keep the winning credits and continue base game play upon making another wager. Alternatively, the controller 200 may “sweeten”, or enhance the offer award option 626 displayed to the player to encourage its selection (step 318). The offer may be enhanced in one of any number of ways including, but not limited to, making chosen reel symbols “wild”, doubling, tripling, etc. the value of selected symbols or the value payout, right to left pays, payouts based on a scattered winning symbol array rather than a pay line winning symbol array, etc.

If the player selects the enhanced offer award option, the player trades the winning credits for the enhanced offer award option and the controller 200 enables the additional base game play reflected in the enhanced offer award option (step 322). If the player declines the enhanced offer award option and instead selects the keep pay option 624, the player keeps the winning credits resulting from the winning symbol combination (step 324) and base game play continues when the controller 200 detects another wager (step 302). Alternatively, if the player declines the enhanced offer award option, the controller 200 may cause the animated character 620 to further enhance the enhanced offer award option, and so on.

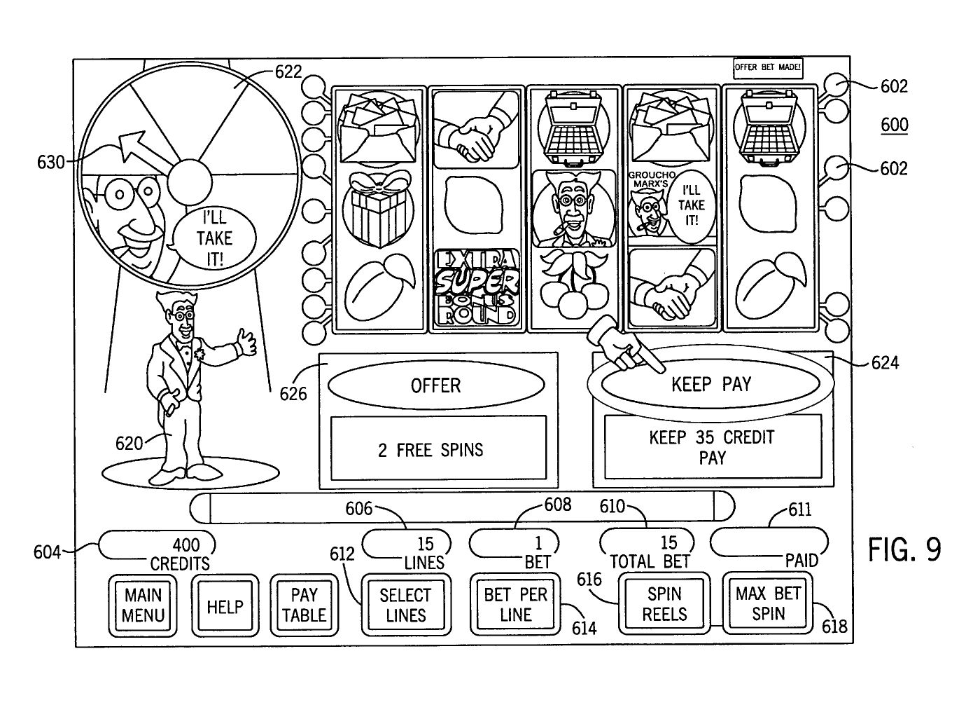

FIG. 9 shows an embodiment of the exemplary video display 600 where the player declines to exercise the offer award option 626 and instead chooses to keep the winning credits by selecting the keep pay option. In the illustrated example, the player chooses to keep his/her 35 winning credits and therefore not trade them for two free spins displayed in the offer award option 626. The player may choose to keep the winning credits and forgo the offer award option 626 for any number of reasons including the award option meter 622 indicating an average offer award option or the offer award option 626 simply not being enough to interest the player when compared to the keep pay option.

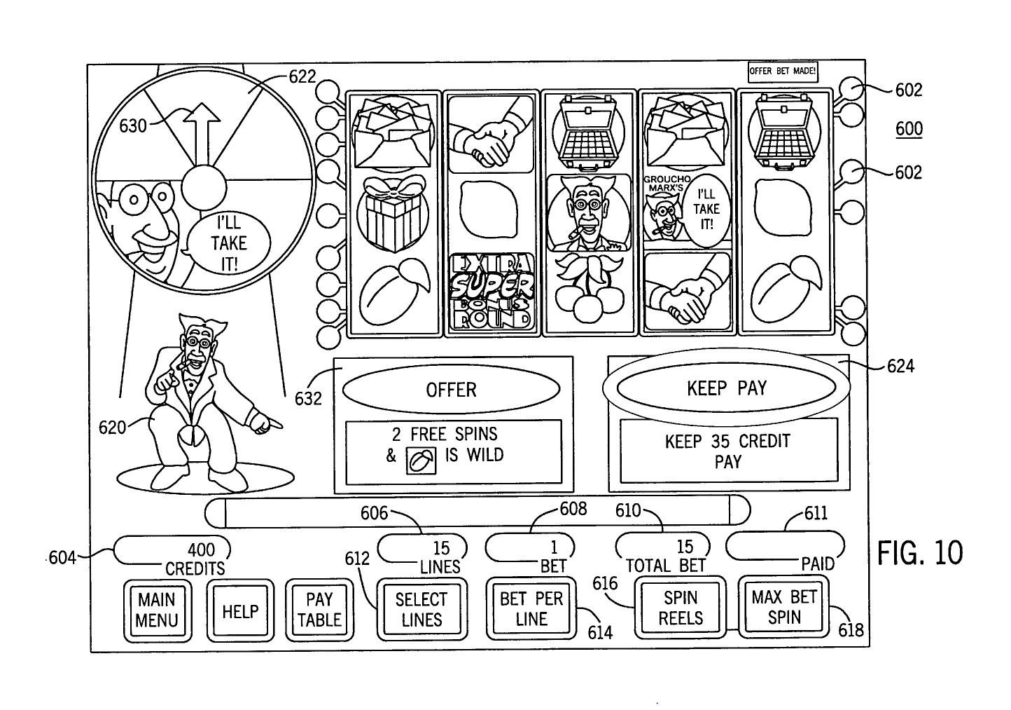

FIG. 10 shows an embodiment of the exemplary video display 600 where the deal is enhanced after the player selected the keep pay option 624 over the offer award option 626. In the illustrated example, upon player selection of the keep pay option 624, the controller 200 enhances the original two free spins shown in FIG. 9 with the addition of the wild symbol (e.g., the plum) thereby resulting in an enhanced offer award option 632. If the player selects the enhanced offer award option 632, the player trades the winning credits (i.e., 35 credits) for the enhanced offer award option 632 and performs the additional base game play reflected in the enhanced offer award option 632. If the player declines the enhanced offer award option 632 and instead exercises the keep pay option 624, the player keeps the winning credits and base game play continues when the controller 200 detects a wager. Alternatively, when the player declines the enhanced offer award option 632, the controller 200 may further enhance the enhanced offer award option 632.

For illustrative purposes above, the options discussed in connection with the award-trading scheme routine 300 are provided to the player in response to an occurrence of a winning symbol combination. It should be understood however, that the award options may be provided to the player in response to an occurrence of a pre-selected symbol or a symbol combination during base game play. The award options may also be provided to the player as a result of operation of the random output generator device, or may be provided based on predetermined criterion such as player identity, promotional events, the number of base games played, a dollar amount or credit amount played or won by the player, player tracking data, the time of day, day of week, etc.

II. Award-Trading Scheme Where Value Payout is Not Displayed

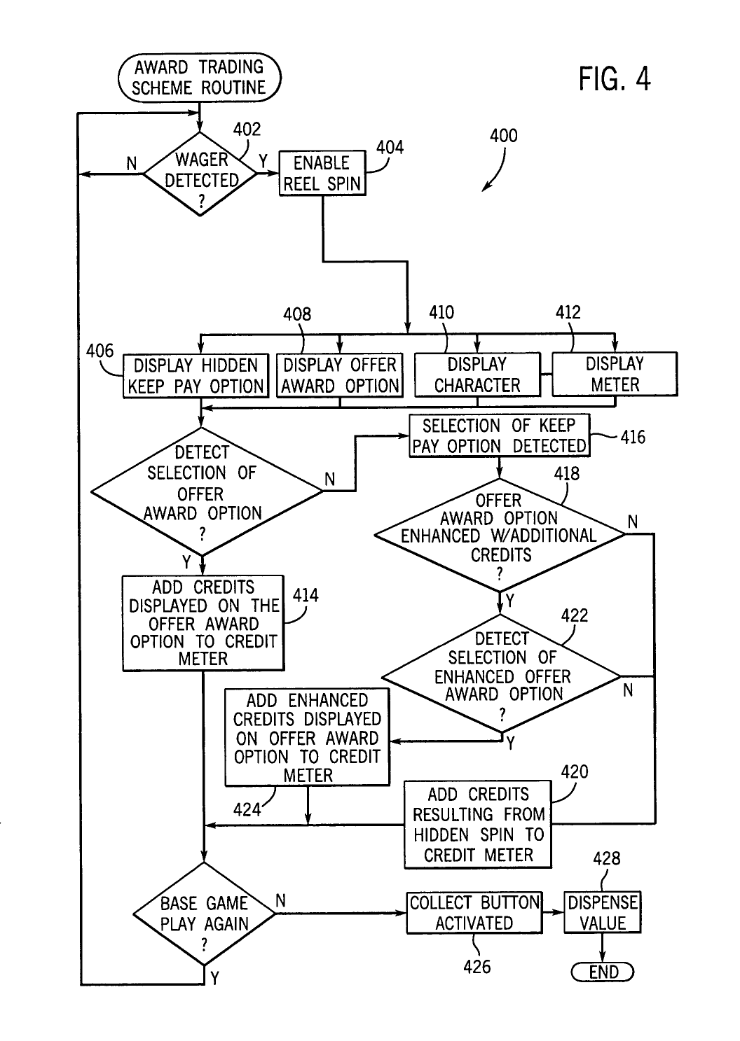

In yet another embodiment of the invention, upon completion of the reel spin, the controller 200 may cause the game outcome to be hidden from the player. FIG. 4 is a flowchart of another embodiment of an award-trading scheme routine 400 that may be performed during operation of the gaming machine of FIG. 1. Referring to FIG. 4, upon completion of the reel spin (step 404), the controller 200 causes the game outcome (i.e., the symbol array) to be hidden from the player (step 406). As with the award-trading scheme routine 300, the player is then directed to select either an offer award option 626 or a keep pay option 624. The player, however, does not know the value of the keep pay option 624. In fact, the player does not know whether a winning symbol combination resulted from the reel spin. Thus, the player must determine whether the offer award option 626 represents a bigger value payout than the keep pay option 624 without seeing the value pay out of the keep pay option 624.

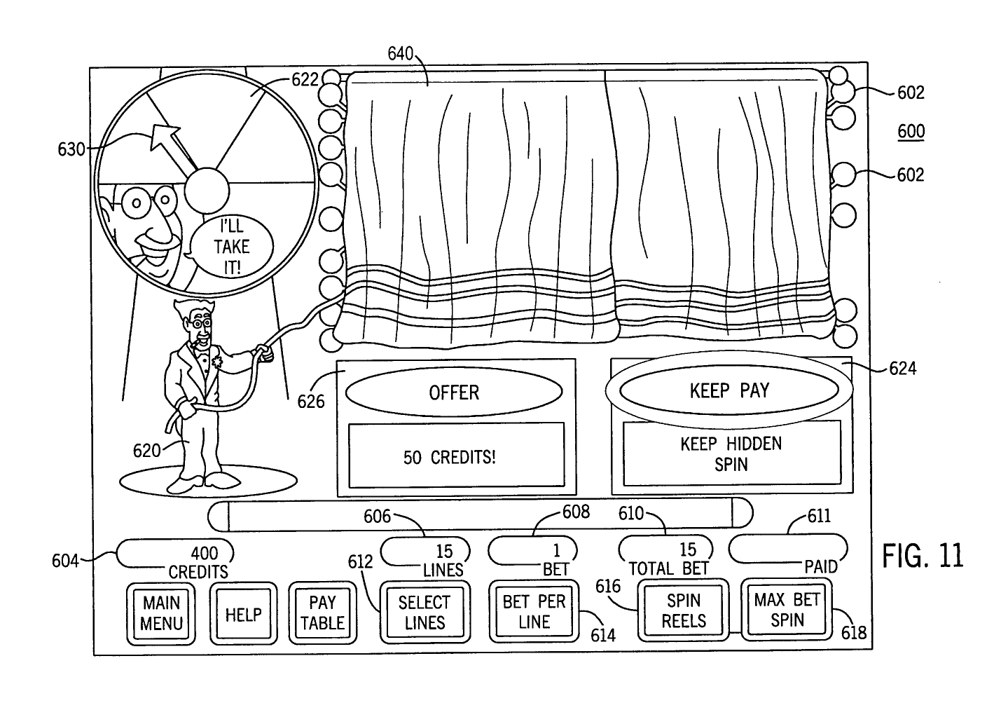

FIG. 11 shows one embodiment of the exemplary display screen 600 that may be displayed upon completion of a winning reel spin during the award-trading scheme routine 400 when the value pay out is not displayed. In keeping with the game theme described above, the game outcome is preferably hidden from the player via a video image of curtains 640 covering the symbol array and appearing to be controlled by the animated character 620. Again, the controller 200 causes an animated character 620 (e.g., Grouch Marx) and an award option meter 622 to be displayed (FIG. 4, steps 410 and 412) on the main display device 31 along side of the stopped video reels. In addition, the controller 200 causes a plurality of options to be displayed; in this case, the offer award option 626 and the keep pay option 624 with the value pay out of the keep pay option 624 hidden. In the illustrated example, if the player selects the offer award option initially displayed, 50 additional credits are added to the credit meter 604 (FIG. 4, step 414). If the player selects the keep pay option 624 (FIG. 4, step 416), the credits resulting from the hidden reel spin may be revealed and added to the credit meter 604 (FIG. 4, step 420). Alternatively, the controller 200 may cause the animated character 620 to enhance the offer award option 630 (FIG. 4, step 418, step 422, step 424) as described above in connection with FIG. 3.

III. Bonus Award-Trading Scheme

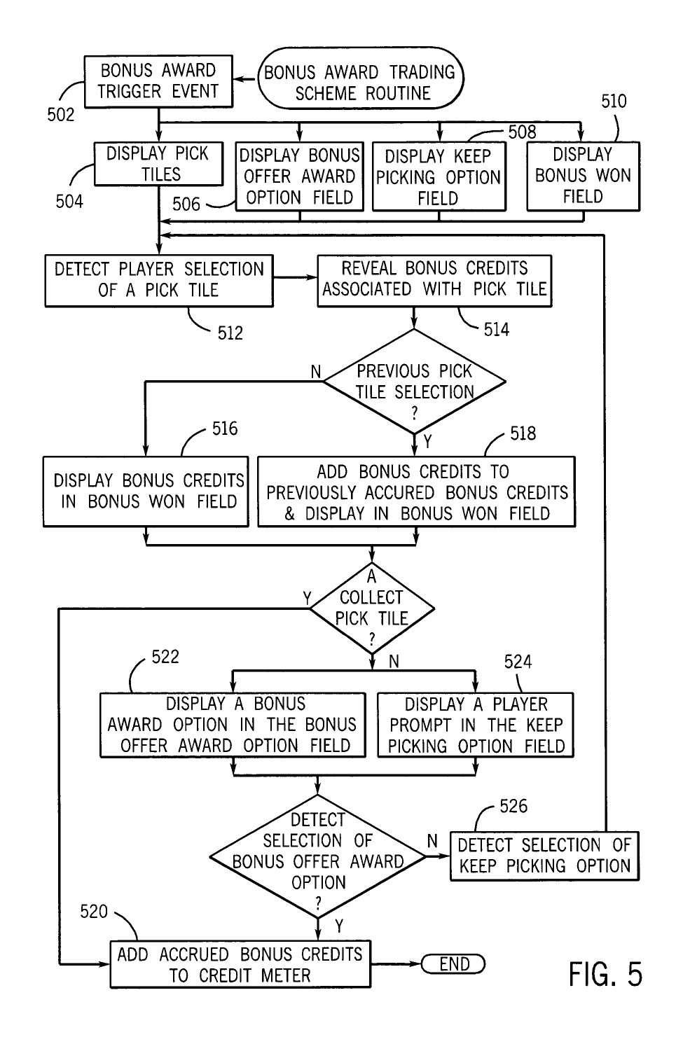

As previously mentioned, the offer award option 626 may reflect one of any number of award options including a chance to play a bonus award-trading game. FIG. 5 is a flowchart of a bonus award-trading scheme routine scheme 500 that may be performed by the controller 200 of the gaming machine in conjunction with the base game play award-trading scheme described above. Although discussed below in the context of a slot game for illustrative purposes, it is contemplated the bonus award-trading scheme routine 500 may be executed in conjunction with any number of other wagering base or bonus games provided by gaming machines.

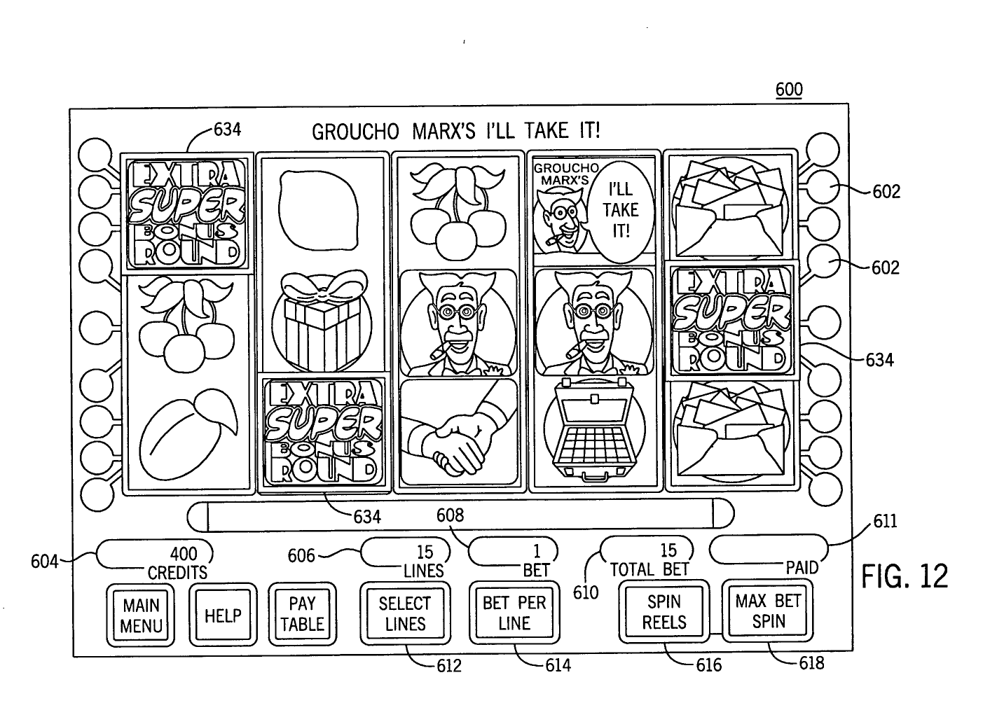

Referring to FIG. 5, the bonus award-trading scheme routine 500 begins operation when the controller 200 causes a bonus triggering event to occur (step 502). Although the bonus triggering event is preferably caused by (1) an occurrence of a pre-selected symbol or a symbol combination during base game play (e.g., an occurrence of three “Extra Super Bonus Round” symbols 634 shown in FIG. 12), it may also be caused by an occurrence of (2) the offer award option 626, (3) predetermined criterion such as player identity, promotional events, the number of base games played, a dollar amount or credit amount played or won by the player, player tracking card data, the time of day, day of week, etc., or (4) a random event from the random output generator device.

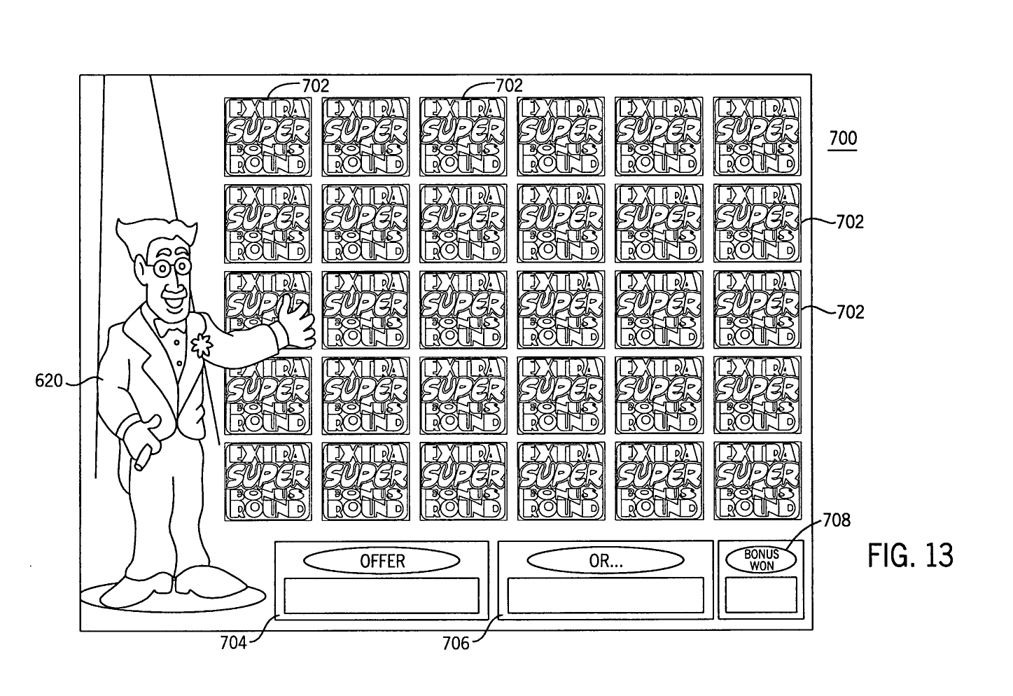

Upon the occurrence of a bonus triggering event, the controller 200 causes a bonus award-trading screen 700 to be displayed on the main display device 31. Referring to FIG. 13, the bonus award-trading screen 700 preferably includes a pick tile array having a number of pick tiles 702 and the animated character 620. The bonus award-trading screen 700 also includes a bonus award option field 704, a keep picking option field 706, and a bonus won field 708. Thus, upon triggering the bonus award-trading scheme routine 500, the pick tiles 702 are displayed (step 504), the bonus award option field 704 is displayed (step 506), the keep picking option field 706 is displayed (step 508), the bonus won field 708 is displayed (step 510), and the animated character 620 is displayed.

Referring again to FIG. 5, when the controller 200 detects player selection of one of the pick tiles (step 512), bonus credits associated with the pick tile are revealed (step 514). If the selection is the first player selection, the bonus credits are displayed in the bonus won field 708 (step 516). If the selection is the second, third, fourth, etc. player selection, the bonus credits are added to previously accrued bonus credits and displayed in the bonus won field 708 (step 518). If the pick tile 702 is a collect pick tile signaling an end to the bonus award-trading scheme routine 500, the bonus credits are added to a credit meter of the gaming machine 10 and the bonus award-trading scheme routine 500 ends.

If the pick tile 702 is not a collect pick tile, the controller 200 displays a bonus award option in the bonus award option field 704 (step 522). The bonus award option is preferably a credit amount greater than the bonus credits displayed in the bonus won field 708. The controller 200 also displays a player prompt in the keep picking option field 706 (step 524). The player may then exercise the bonus award option by selecting, or touching, the bonus award option field 704, or the player may continue with the pick tile selection process by selecting the keep picking option field 706. As in the award-trading scheme routines 300 and 400, the animated character 620 “talks” to the player during the bonus award-trading scheme routine 500.

If the player exercises the bonus award option, the total bonus credits displayed in the bonus won field 708 are added to the credit meter and the bonus award-trading scheme routine 500 ends (step 520). Thus, the player “trades” the (1) bonus award option displayed in the bonus award option field 704 for (2) the total credits displayed in the bonus won field 708 and the opportunity for additional pick tile selections. As a result, unlike prior art bonus trading games that allow a player to pick between either a first or second option or trade the first or second option for a third option such that the player ultimately picks between two options with no further picks, during the bonus award-trading scheme routine 500 the player trades accumulated credits plus possible further pick tile selections for the bonus award option.

If the keep picking option field 706 is selected (step 526), the player is precluded from receiving the bonus award option displayed in the bonus award option field 704 and instead is allowed to select another pick tile 702 and accrue possible additional credits. That pick tile may or may not be a collect pick tile. The bonus award-trading scheme routine 500 continues until all pick tiles have been selected, a collect pick tile is revealed, or the player exercises the bonus award option.

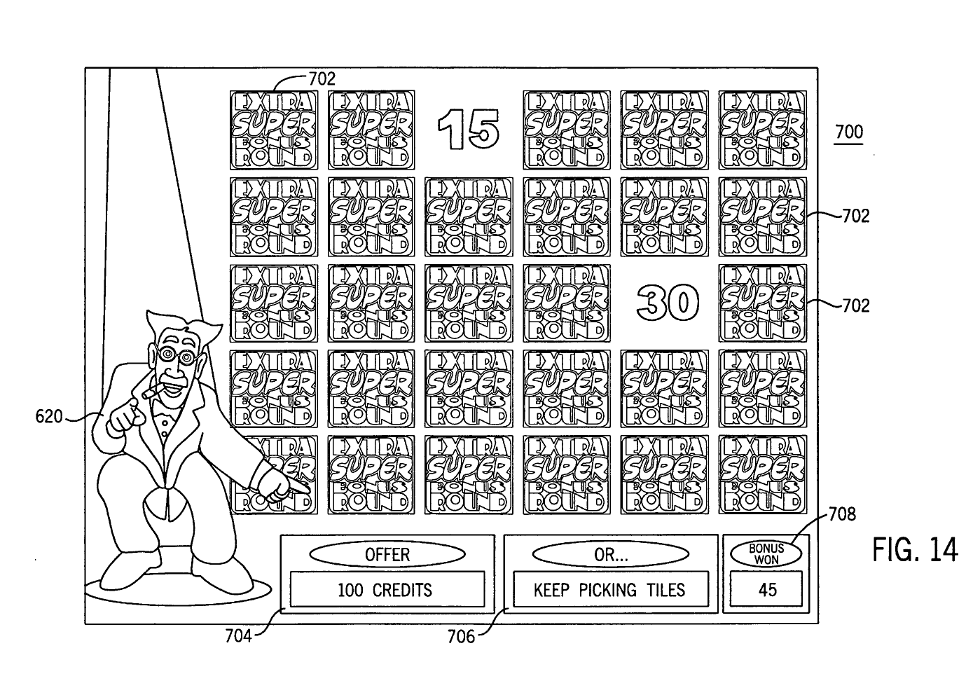

For example FIG. 14 shows an embodiment of the bonus award-trading screen 700 where two pick tiles have been selected and have resulted in 45 total bonus credits in the bonus won field 708. The bonus award option field 704 displays 100 credits and the keep picking option field 706 displays the player prompt, “keep picking tiles”. Thus, the player can either select the bonus award option 704 and receive 100 credits thereby ending the bonus award-trading scheme routine 500, or select the keep picking option thereby enabling selection of another pick tile.

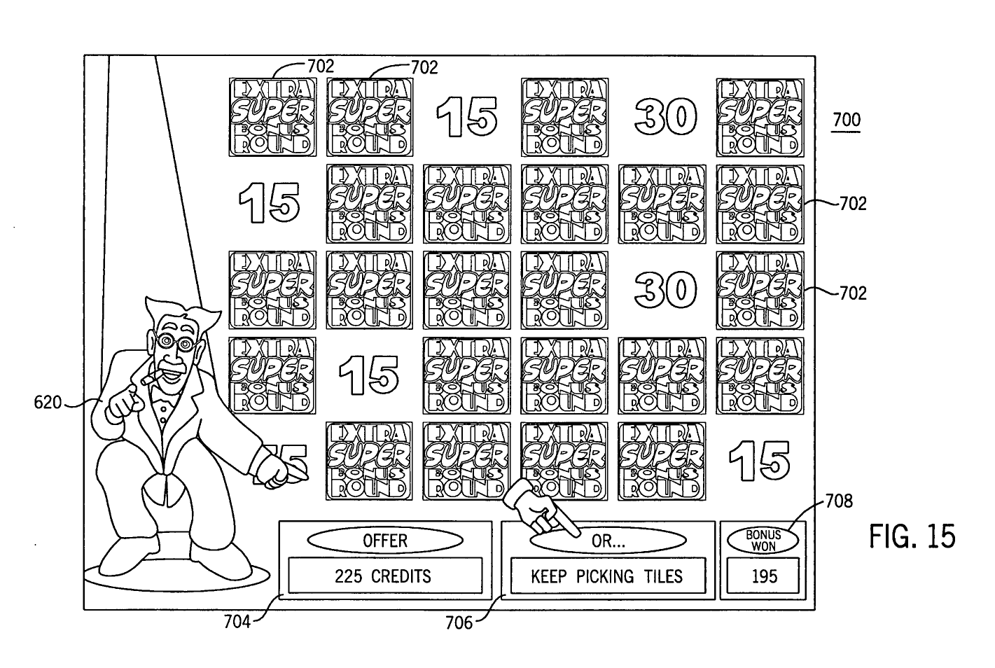

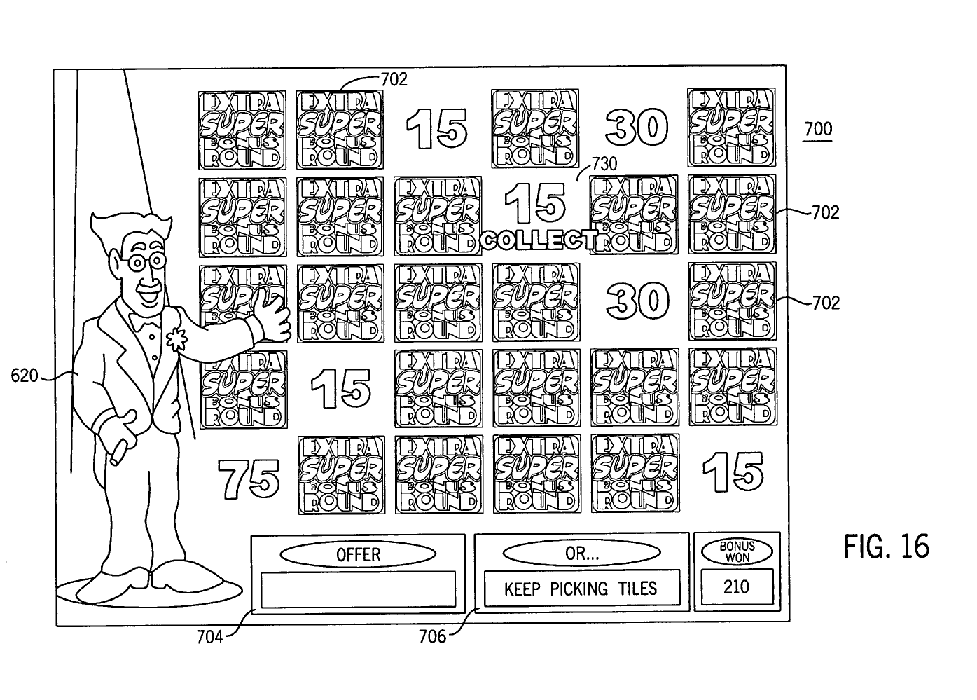

Similarly, FIG. 15 shows an embodiment of the bonus award-trading video screen 700 where seven pick tiles have been selected and have resulted in 195 total bonus credits in the bonus won field 708. The bonus award option field 704 displays 255 credits and the keep picking option field 706 displays the player prompt. In this case, the player selects the keep picking option field 706. Next, the player uncovers a collect pick tile 730 (see, FIG. 16), and as a result, the bonus option is no longer displayed in the bonus award option field 704 and the 210 total bonus credits in the bonus won field 708 are added to the credit meter indicating an end to the bonus award-trading scheme routine 500. The player ends the bonus award-trading scheme routine 500 having accumulated 210 credits.

Although the award-trading scheme routine 500 is described above as having thirty pick tiles that may be randomly selected until all thirty pick tiles are reveled, a collect pick tile is revealed, or the player exercises the bonus award option, other embodiments are contemplated that additionally include revealing statistical information to the player and/or that have different numbers of pick tiles. For example, there may be twenty pick tiles and the player may be told by the animated character 430 that there are four pick tiles worth 20 credits, four pick tiles worth 40 credits, four pick tiles worth 60 credits, four pick tiles worth 80 credits, and four pick tiles worth 100 credits. As the tiles are selected by the player, knowledge of the outstanding credit values combined with the credits displayed in bonus award option field 704 adds another level of player excitement during bonus game play.

As may be apparent from the discussion above, the present invention providing a gaming machine having an award-trading scheme during base game play provides that the player does not have to wait for an occurrence of a bonus triggering event and bonus game play in order to the enjoy the benefits associated with bonus game play. Instead, the player is presented with award options during base game play which, depending on the award option selected, provide unpredictable and fun game play variations during the base game.

From the foregoing, it will be observed that numerous variations and modifications may be affected without departing from the scope of the novel concept of the invention. It is to be understood that no limitations with respect to the specific methods and apparatus illustrated herein is intended or should be inferred. It is, of course, intended to cover by the appended claims all such modifications as fall within the scope of the claims.

1. A method of conducting a wagering base game comprising:
receiving a wager to play the wagering base game;
detecting a winning outcome to the wagering base game, the winning outcome resulting in winning credits;
providing a first award option to a player of the wagering base game, the first award option displayed on a video display of the gaming machine; and
in response to the first award option being exercised by the player, precluding the player from receiving the winning credits and awarding the first award option to the player.

2. The method of conducting the wagering base game of claim 1, wherein the gaming machine is a video slot machine, and wherein the first award option comprises at least one free reel spin.

3. The method of conducting the wagering base game of claim 1, wherein the first award option comprises base game play not requiring a wager.

4. The method of conducting the wagering base game of claim 3, wherein the first award option further comprises an occurrence of a multiplied winning outcome associated with the base game play not requiring a wager.

5. The method of conducting the wagering base game of claim 3, wherein the first award option further comprises a credit amount.

6. The method of conducting the wagering base game of claim 3, wherein the first award option further comprises an occurrence of at least one enhanced symbol associated with the base game play not requiring a wager.

7. The method of conducting the wagering base game of claim 1, wherein providing the first award option comprises:
displaying a keep pay option on the video display, wherein selection of the keep pay option allows the player to keep the winning credits and precludes the player from exercising the first award option;
displaying an animated character on the video display, the animated character appearing to give verbal instructions to the player; and
displaying an option award meter on the video display, the option award meter providing a visual indication of a first award option value.

8. The method of conducting the wagering base game of claim 7, wherein the option award meter comprises a circular disk having a plurality of colored wedges and a rotatable pointer, each of the plurality of colored wedges associated with a different value, the rotatable pointer indicating one of the plurality of colored wedges.

9. The method of conducting the wagering base game of claim 1, wherein in response to the first award option not being exercised by the player, providing a second award option, the second award option replacing the first award option, the second award option more valuable to the player than the first award option.

10. The method of conducting the wagering base game of claim 1, wherein the first award option comprises an occurrence a bonus game.

11. The method of conducting the wagering base game of claim 10, wherein the bonus game comprises:
providing a plurality of pick tiles on the video display, each of the plurality of pick tiles associated with a hidden credit award;
detecting player selection of a first pick tile of the plurality of pick tiles, player selection of the first pick tile revealing a first credit award to the player;
providing a first bonus award option to the player; and
in response to the first bonus award option being exercised by the player, precluding the player from receiving the first credit award and awarding the first bonus award option to the player.

12. The method of conducting the wagering base game of claim 11, wherein the first bonus award option comprises bonus award credits, the bonus award credits being greater than the first credit award.

13. The method of conducting the wagering base game of claim 11, further comprising precluding the player from selecting a second pick tile of the plurality of pick tiles in response to the first bonus award option being exercised by the player.

14. The method of conducting the wagering base game of claim 13, wherein in response to the first bonus award option not being exercised by the player, enabling player selection of the second pick tile, the second pick tile associated with a second credit award.

15. The method of conducting the wagering base game of claim 14, further comprising:
detecting player selection of the second pick tile;
displaying a sum of the first credit award and the second credit award on the video display;
providing a second bonus award option to the player;
in response to the second bonus award option being exercised by the player, precluding the player from receiving the sum of the first credit award and the second credit award and awarding the second bonus award option to the player; and
precluding the player from selecting a third pick tile of the plurality of pick tiles.

16. The method of conducting the wagering base game of claim 14, further comprising awarding the sum of the first credit award and the second credit award to the player if the second pick tile comprises a collect pick tile, the collect pick tile indicating an end to bonus game play.

17. A method of conducting a wagering base game comprising:
receiving a wager to play the wagering base game;
concealing from the player an outcome to the wagering base game;
providing a first award option to the player, the first award option displayed on a video display of the gaming machine; and
in response to the first award option being exercised by the player, precluding the player from receiving winning credits associated with the outcome and awarding the first award option to the player.

18. The method of conducting a wagering base game of claim 17, wherein the first award option comprises base game play not requiring a wager.

19. The method of conducting a wagering base game of claim 17, wherein the first award option comprises first award credits.

20. The method of conducting the wagering base game of claim 17, wherein providing the first award option comprises:
displaying a keep pay option on the video display, wherein player selection of the keep pay option allows the player to keep winning credits associated with the outcome and precludes the player from exercising the first award option;
displaying an animated character on the video display, the animated character appearing to give verbal instructions to the player; and
displaying an option award meter on the video display, the option award meter providing a visual indication of a first award option value.

21. The method of conducting a wagering game of claim 17, wherein in response to the first award option not being exercised by the player, providing a second award option, the second award option more valuable to the player than the first award option.

22. The method of conducting a wagering base game of claim 21, wherein the second award option comprises second award credits, the second award credits greater than the first award credits.

23. A gaming machine for conducting a wagering base game, the gaming machine comprising:
a value input device;
a video display for displaying video images associated with the wagering base game; and
a controller operatively coupled to the value input device and the video display, the controller comprising a processor and a memory coupled to the processor, the controller being programmed to:
receive a wager to play the wagering base game,
detect a winning outcome to the wagering base game, the winning outcome resulting in winning credits,
provide a first award option to a player of the wagering base game, the first option displayed on a video display of the gaming machine, and
in response to the first award option being exercised by the player, preclude the player from receiving the winning credits and awarding the first award option to the player.

24. The gaming machine of claim 23, wherein the gaming machine is a video slot machine, and wherein first award option comprises at least one free reel spin.

25. The gaming machine of claim 23, wherein the first award option comprises base game play not requiring a wager.

26. The gaming machine of claim 25, wherein the first award option further comprises an occurrence of a multiplied winning outcome associated with the base game play not requiring a wager.

27. The gaming machine of claim 25, wherein the first award option further comprises a credit amount.

28. The gaming machine of claim 25, wherein the first award option further comprises an occurrence of at least one enhanced symbol associated with the base game play not requiring a wager.

29. The gaming machine of claim 23, wherein the controller is further programmed to:
display a keep pay option on the video display, wherein player selection of the keep pay option allows the player to keep the winning credits and precludes the player from exercising the first award option;
display an animated character on the video display, the animated character appearing to give verbal instructions to the player; and
display an option award meter on the video display, the option award meter providing a visual indication of a first award option value.
